(19) United States
(12) Patent Application Publication
(10) Pub. No.: US 2012/0102401 A1
(43) Pub. Date: Apr. 26, 2012

(54) METHOD AND APPARATUS FOR PROVIDING TEXT SELECTION

(75) Inventors: Jari Ijas, Espoo (FI); Rit Mishra, Helsinki (FI); Jonatan Hedberg, Helsinki (FI)

(73) Assignee: Nokia Corporation

(21) Appl. No.: 12/911,387

(22) Filed: Oct. 25, 2010

(51) Int. Cl. G06F 3/01

(52) U.S. Cl. 715/702

(57) ABSTRACT

A method for providing selection of a portion of text for touch screen devices may include receiving an indication of a touch gesture in association with a primary word among text being displayed at a touch screen display, causing provision of a selected word indication to indicate inclusion of the primary word as a selected word, causing provision of a pre-selected word indication in relation to at least one secondary word adjacent to the primary word, and enabling expansion of the selected word indication to include the at least one secondary word in response to a touch event selecting the at least one secondary word. A corresponding apparatus and computer program product are also provided.

### TECHNOLOGICAL FIELD

Some example embodiments of the present invention relate generally to user interface technology and, more particularly, relate to a method and apparatus for providing selection of a portion of text.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, electronic book or reading device, etc.

In many situations, it may be desirable for the user to interface with a device such as a mobile terminal for the provision of an application or service. A user's experience during certain applications such as, for example, web browsing or navigating through content may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays. As such, touch screen devices are now relatively well known in the art, with numerous different technologies being employed for sensing a particular point at which an object may contact the touch screen display.

### BRIEF SUMMARY

A method, apparatus and computer program product are provided to enable the use of a touch screen display for selecting a portion of text. In particular, a method, apparatus and computer program product are provided that may enable the user to utilize a long press (or press and hold) event sensed at a touch screen display of a device for selecting primary and secondary words where the secondary words selected are adjacent to the primary word selected.

In an example embodiment, a method for providing selection of a portion of text for touch screen devices is provided. The method may include receiving an indication of a touch gesture in association with a primary word among text being displayed at a touch screen display, causing provision of a selected word indication to indicate inclusion of the primary word as a selected word, causing provision of a pre-selected word indication in relation to at least one secondary word adjacent to the primary word, and enabling expansion of the selected word indication to include the at least one secondary word in response to a touch event selecting the at least one secondary word.

In another example embodiment, a computer program product for providing selection of a portion of text for touch screen devices is provided. The computer program product may include at least one computer-readable storage medium having computer-executable program code instructions stored therein. The computer-executable program code instructions may include program code instructions for receiving an indication of a touch gesture in association with a primary word among text being displayed at a touch screen display, causing provision of a selected word indication to indicate inclusion of the primary word as a selected word, causing provision of a pre-selected word indication in relation to at least one secondary word adjacent to the primary word, and enabling expansion of the selected word indication to include the at least one secondary word in response to a touch event selecting the at least one secondary word.

In another example embodiment, an apparatus for providing selection of a portion of text for touch screen devices is provided. The apparatus may include at least one processor and at least one memory including computer program code. The at least one memory and the computer program code may be configured to, with the at least one processor, cause the apparatus at least to perform receiving an indication of a touch gesture in association with a primary word among text being displayed at a touch screen display, causing provision of a selected word indication to indicate inclusion of the primary word as a selected word, causing provision of a pre-selected word indication in relation to at least one secondary word adjacent to the primary word, and enabling expansion of the selected word indication to include the at least one secondary word in response to a touch event selecting the at least one secondary word.

In another example embodiment, an apparatus for providing selection of a portion of text for touch screen devices is provided. The apparatus may include means for receiving an indication of a touch gesture in association with a primary word among text being displayed at a touch screen display, means for causing provision of a selected word indication to indicate inclusion of the primary word as a selected word, means for causing provision of a pre-selected word indication in relation to at least one secondary word adjacent to the primary word, and means for enabling expansion of the selected word indication to include the at least one secondary word in response to a touch event selecting the at least one secondary word.

Some embodiments of the invention may provide a method, apparatus and computer program product for improving user experience relating to devices having touch screen interfaces. As a result, for example, mobile terminal users may enjoy improved capabilities with respect to selecting text or words within a document or page that is displayed. As such, in some cases, other services or applications that may be used in connection with the selected text may be accessed with less user interaction.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing selection of a portion of text for touch screen devices according to an example embodiment of the present invention;

FIG. 3 illustrates a view of a display showing text selection according to an example embodiment of the present invention;

FIG. 4 illustrates a view of a display showing text selection according to another example embodiment of the present invention;

FIG. 5 illustrates a view of a display showing text selection according to yet another example embodiment of the present invention; and

FIG. 6 is a block diagram according to an example method for providing selection of a portion of text for touch screen devices according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the selection of text on a touch screen display. As discussed above, user interfaces that include touch screen displays are becoming increasingly popular. One reason for such popularity is the intuitive nature of performing functions directly with the objects that are displayed rather than using a keyboard, joystick or other user interface device to indirectly interface with the objects. In addition to being relatively intuitive, interactions with touch screen displays may often eliminate or substantially reduce the requirements for users to know ahead of time what can be accomplished via the usage of various selection mechanisms, keys and/or key combinations. Moreover, using a touch screen display may sometimes reduce the overall number of selections, key presses, or other discrete interactions the user needs to make to accomplish a task.

Using some example embodiments, a user may be enabled to interact with a touch screen display that is displaying text in order to select a word as a primary word using a single input event (e.g., a long press or touch-and-hold) on the word and to designate one or more secondary words using the same single input event. In some examples, the primary word may be highlighted or otherwise indicated as the selected word and the secondary words may be highlighted or indicated differently from that which is used for the primary word. The secondary words may be the words immediately adjacent to the primary word (e.g., the word before and the word after the primary word). In some embodiments, the secondary words may essentially be designated as being “preselected” insofar as the secondary words may be highlighted and selectable with a tap or other single press input event. Thus, some embodiments may enable highlighting or otherwise selecting of multiple words, including the primary word and the secondary words, with a single input event. Other functions, actions and/or services may be performed with respect to the primary word and/or selected secondary words after the selection of the primary and/or secondary words according to available options associated with an application being run or capable of being run. For example, a search may be performed, spelling and/or grammar correction services may be performed, a word or words may be copied, edit options may be presented, hyperlinks may be added or activated, another application may be launched with respect to a selected word or based on a selected word (e.g., initiating a call, email or message service) or options for launching such an application may be provided, and numerous other functions may be accomplished.

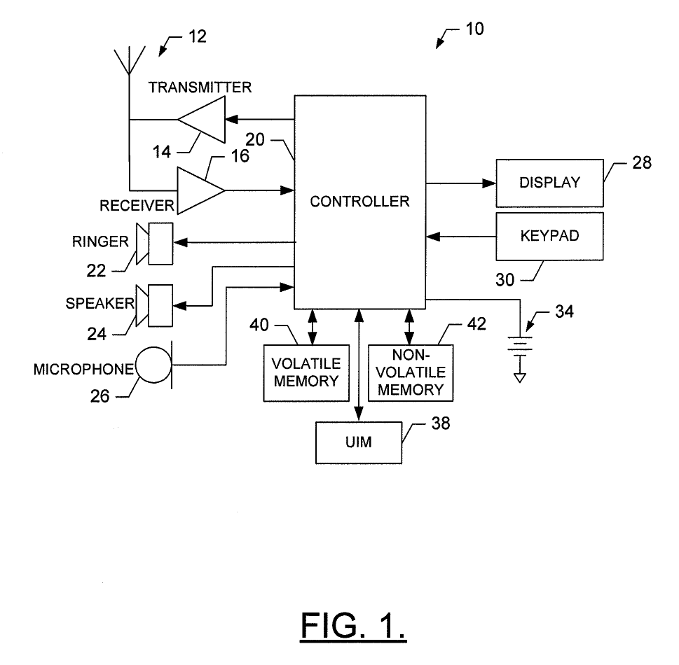

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

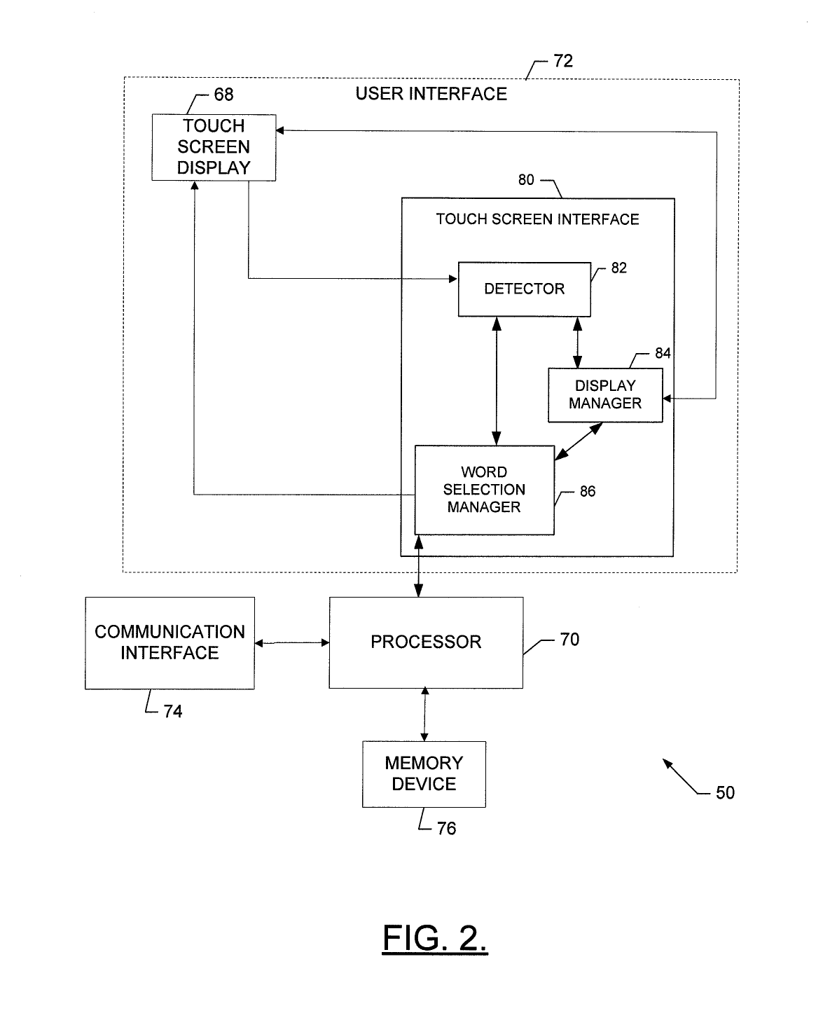

The mobile terminal 10 may include an antenna 12 (or multiple antennas) in operable communication with a transmitter 14 and a receiver 16. The mobile terminal 10 may further include an apparatus, such as a controller 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the invention will now be described with reference to FIG. 2, in which certain elements of an apparatus 50 for providing selection of a portion of text for touch screen devices are displayed. The apparatus 50 of FIG. 2 may be employed, for example, in conjunction with the mobile terminal 10 of FIG. 1. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of an apparatus for providing selection of a portion of text for touch screen devices, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for providing selection of a portion of text for touch screen devices is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or other like hardware devices. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84 and a word selection manager 86. Each of the detector 82, the display manager 84 and the word selection manager 86 may be any device or means embodied in either hardware or a combination of hardware and software configured to perform the corresponding functions associated with the detector 82, the display manager 84 and the word selection manager 86, respectively, as described herein. In an exemplary embodiment, each of the detector 82, the display manager 84 and the word selection manager 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area or the detection of a change in the electrostatic field of the touch screen display 68 at a particular location. As such, some touch events may not actually require physical contact with the touch screen display 68. Subsequent to each touch event, the detector 82 may be further configured to recognize and/or determine a corresponding classification of the event. In other words, the detector 82 may be configured to classify the touch event as any of a number of possible gestures. Some examples of recognizable gestures may include a touch, multi-touch, stroke, character, pinch event (e.g., a pinch in or pinch out), a tap, a long press, and/or the like.

A touch may be defined as a touch event that impacts a single area (without or with minimal movement on the surface of the touch screen display 68) and then is removed. A multi-touch may be defined as multiple touch events sensed at the same time (or nearly the same time). A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart, followed by movement of the objects initiating the multi-touch substantially toward each other. Meanwhile, a pinch out may be defined as a multi-touch, where the touch events causing the multi-touch are relatively close together, followed by movement of the objects initiating the multi-touch substantially away from each other. A tap and a long press may each be specific classes of touch event that are distinguishable based on the time the touch event lasts. For example, a tap may be a brief touch (e.g., a touch followed very soon thereafter by removal of the object from contact with the touch screen display 68). Meanwhile, a long press may be characterized by a touch or press on the screen that is held for at least a threshold amount of time to enable recognition of the touch event as a long press. The long press may sometimes be referred to as a “press-and-hold” event. In some cases, the detector 82 may be further enabled to determine characteristics regarding the touch events (e.g., length of time of a touch event, length of movement, direction of movement and/or speed of movement of the object). As such, the detector 82 may classify the touch events relative to various thresholds or ranges of lengths (in terms of time and distance), directions and/or speeds of movement.

In an example embodiment, the detector 82 may be configured to communicate detection information regarding the recognition, detection and/or classification of a touch event to the display manager 84 and/or the word selection manager 86. The display manager 84 may be configured to provide control over modifications made to that which is displayed on the touch screen display 68 based on input from the word selection manager 86 responsive to the detection information received from the detector 82. As such, the word selection manager 86 may be configured to receive detection information from the detector 82 and initiate functionality based on the detection information. In an example embodiment, the word selection manager 86 may be configured to provide for selection of a primary word and designation of one or more secondary words responsive to detection of a long press in association with the primary word. Both the primary word and the secondary words may be highlighted in some fashion to indicate their selection and/or designation as primary and secondary words, respectively. After selection of the primary word with a long press, and the corresponding designation of secondary words based on the selection of the primary word, the word selection manager 86 may also enable selection of one of the secondary words in response to detection of a tap at the location of the selected one of the secondary words. The primary word may initially be “selected” while the secondary words are “pre-selected”. However, the secondary words may also be selected by tapping thereon as described below. In some cases, when one secondary word is selected by tapping thereon, the adjacent word thereto (that was not previously selected or pre-selected) may become pre-selected. Thus, the expansion of selected text may be affected by continued tapping on pre-selected words.

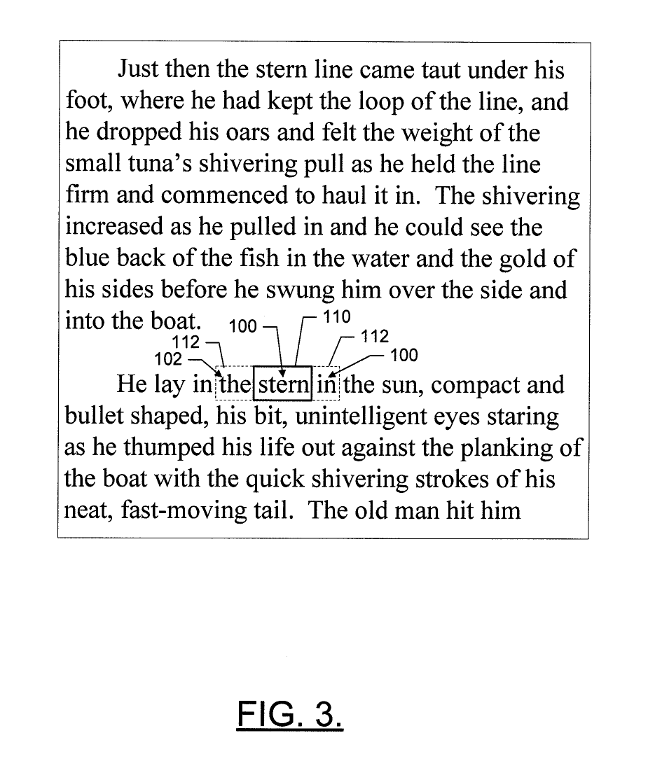

FIGS. 3-5 illustrate examples of text selection according to some example embodiments with different highlighting options presented. In each of FIGS. 3-5, a sample text is displayed with a plurality of words. In the context of example embodiments, a word may be considered to be any collection of characters located in a text sample that have a particular meaning associated therewith. Thus, a word could be any collection of letters, characters and/or symbols that are positioned proximate to each other and associated with one another to convey a particular meaning or provide a representation. Thus, not only could a word be set of letters that define an entry that could be located in a common dictionary, but a word could also be an acronym, a number, a collection of letters and numbers or any other combination of characters that are placed together to provide a specific meaning or represent something. Words are typically collections of letters, symbols and/or characters that are separated from each other by spaces and/or punctuation marks. As such, it should be appreciated that punctuation marks or typically not parts of words, except perhaps when the punctuation mark is a part of the word (e.g., such as an apostrophe used in a possessive word like “tuna's”).

In FIG. 3, text may be displayed as a portion of a document, web page, or any other text bearing application. In an example embodiment, a long press may be detected (e.g., by the detector 82) in association with the word “stern”. The detector 82 may then communicate the detection to the word selection manager 86. The word selection manager 86 may then instruct the display manager 84 to highlight the word “stern” as a primary word 100 and provide a corresponding selected word indication 110 in association with the primary word 100. The selected word indication 110 may be an indication of a selected word or words. In other words, the selected word indication 110 may be a mechanism by which selected words or highlighted or otherwise indicated as being selected. After the selected word indication 110 is presented, the word selection manager 86 may also instruct the display manager 84 to highlight the words adjacent to the primary word 100 as secondary words 102 and 104 and provide a corresponding “pre-selected” word indication 112 in association with the secondary words 102 and 104. The pre-selected word indication 112 may be an indication of “pre-selected” words and thereby provide a mechanism by which to highlight or indicate words that are designated as secondary words that may be selected (e.g., by tapping thereon) to include the selected words within the selected word indication 110. In the example of FIG. 3, the word “the” is secondary word 102 and the word “in” is secondary word 104. The highlighting may be performed in any suitable manner. For example, the primary word 100 may be highlighted with a different color than the secondary words 102 and 104. Alternatively, the font of primary word 100 may be altered to make it different than that of the secondary words 102 and 104, while the font of the secondary words 102 and 104 may also be altered with respect to that which is provided for remaining portions of the text. As yet another alternative, the primary word 100 and the secondary words 102 and 104 may simply be highlighted by being placed within a geometric shape such as a circle or a rectangle. In the example of FIG. 3, the selected word indication 110 is provided as a rectangle with a solid border that includes all selected words (in this case, just the primary word 100). Meanwhile, the pre-selected word indication 112 is provided as separate rectangles having dashed borders that include the designated words for pre-selection (e.g., the secondary words 102 and 104. The highlighting may appear, for example, after release of the long press. However, in some examples, the highlighting may appear even before release of the long press after a predetermined hold time period has been reached.

In some embodiments, options for additional actions to be taken with respect to selected words (e.g., the primary word 100) may be provided after release of the long press or after completion of extending the selected word indication 110 as described herein. However, it is not necessary that such options be presented automatically. In some other examples, the user may separately select options to be presented or select from presented options with a tap or other touch event.

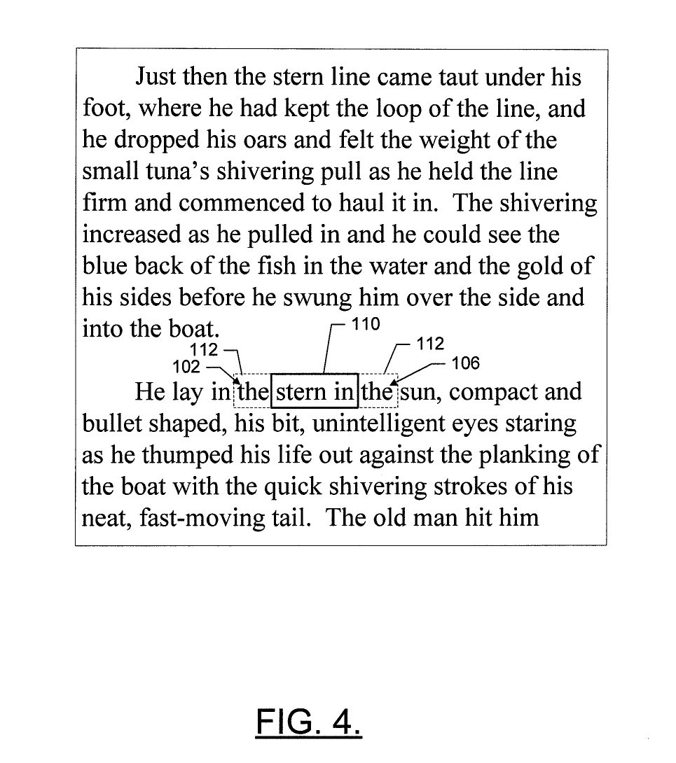

In an example embodiment, only the primary word 100 may initially be within the selected word indication 110. However, the inclusiveness of the selected word indication 110 (e.g., the words within the selected word indication 110) may be expanded by tapping on either one of the pre-selected words (e.g., the secondary words 102 or 104). In this regard, for example, by tapping on the word “in” (e.g., secondary word 104), the selected word indication 110 may expand to include the word “in” as shown in FIG. 4. In some cases, the word adjacent to “in”, which is now a selected word in addition to the primary word 100 and within the selected word indication 110, may become a new secondary word 106. As such, as can be seen in FIG. 4, the word “the” may become the new secondary word 106. The inclusiveness of the amount of text within the selected word indication 110 may therefore be expanded through tapping on secondary words. Each selection that expands the inclusiveness of the selected word indication 110 may also cause the word selection manager 86 to designate a new word as a pre-selected secondary word as the next adjacent word that was not pre-selected or selected. Thus, the secondary words may provide an easy mechanism (e.g., tapping thereon) by which to add words to a group of selected words that are indicated as being selected by the selected word indication 110. Each expansion of the words included in the selected word indication 110 may spread the positioning of the secondary words to the corresponding next adjacent words to the expanded group of selected words. The group of selected words may therefore be grown in either direction in a controlled, but simple manner.

Although the example above refers to expanding the selected word indication 110 via tapping on secondary words, it should be noted that some embodiments may not require a tap directly on the secondary words to affect the expansion. For example, in some cases, a tap near the secondary word may be sufficient to expand the selected word indication. This may account for difficulties in accurately tapping directly on a secondary word in certain small screen or small font environments. In some cases, a threshold distance may be defined relative to borders of the highlighting provided to the secondary words so that any tap within the threshold distance may be interpreted as a tap on the corresponding secondary word. The threshold distance may be a predetermined value or may be variable based on font size, screen size or user preference.

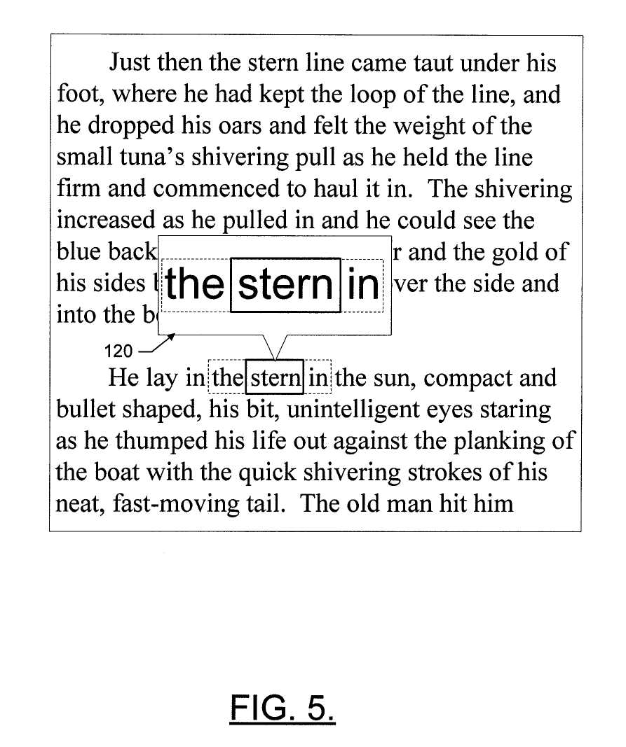

In some embodiments, the selected word indication 110 and/or the pre-selected word indication 112 may simply be provided as an overlay or additional feature shown relative to the existing text. However, in some embodiments, words that have been selected and/or pre-selected may be shown in a blown up, zoomed in, or expanded window 120 as shown in FIG. 5. After selection, any of various functions such as edit options or other functionalities may be performed with respect to the selected words.

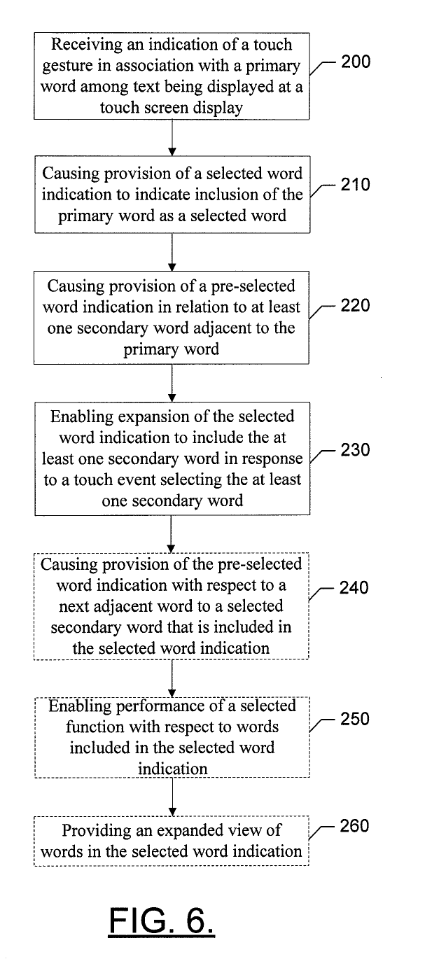

FIG. 6 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 6, may include receiving an indication of a touch gesture (e.g., a long press event, a stroke gesture, a tap, a double tap and/or the like) in association with a primary word among text being displayed at a touch screen display at operation 200, causing provision of a selected word indication (e.g., via a processor) to indicate inclusion of the primary word as a selected word at operation 210, causing provision of a pre-selected word indication in relation to at least one secondary word adjacent to the primary word at operation 220, and enabling expansion of the selected word indication to include the at least one secondary word in response to a touch event selecting the at least one secondary word at operation 230.

In some embodiments, certain ones of the operations above may be modified or further amplified as described below. Moreover, in some embodiments additional optional operations may also be included (some examples of which are shown in dashed lines in FIG. 6). It should be appreciated that each of the modifications, optional additions or amplifications below may be included with the operations above either alone or in combination with any others among the features described herein. In this regard, for example, the method may further include causing provision of the pre-selected word indication with respect to a next adjacent word to a selected secondary word that is included in the selected word indication at operation 240. Alternatively or additionally, the method may include enabling performance of a selected function with respect to words included in the selected word indication at operation 250. Additionally or alternatively, the method may include providing an expanded view of words in the selected word indication at operation 260. In an example embodiment, causing provision of the pre-selected word indication may include causing provision of the pre-selected word indication with respect to a word immediately before the selected word indication and a word immediately after the selected word indication. In some embodiments, the touch event responsive to which the expansion of the selected word indication is provided may include a tap on a secondary word. In some example cases, causing provision of the selected word indication may include highlighting selected words, and wherein causing provision of the pre-selected word indication comprises differently highlighting secondary words positioned adjacent to the selected words.

In an example embodiment, an apparatus for performing the method of FIG. 6 above may comprise a processor (e.g., the processor 70) configured to perform some or each of the operations (200-260) described above. The processor may, for example, be configured to perform the operations (200-260) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-260 may comprise, for example, the touch screen interface 80 (or respective different components thereof). Additionally or alternatively, at least by virtue of the fact that the processor 70 may be configured to control or even be embodied as the touch screen interface 80, the processor 70 and/or a device or circuitry for executing instructions or executing an algorithm for processing information as described above may also form example means for performing operations 200-260.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a touch gesture in association with a primary word among text being displayed at a touch screen display;
causing provision of a selected word indication to indicate inclusion of the primary word as a selected word;
causing provision of a pre-selected word indication in relation to at least one secondary word adjacent to the primary word; and
enabling expansion of the selected word indication to include the at least one secondary word in response to a touch event selecting the at least one secondary word.

2. The method of claim 1, further comprising causing provision of the pre-selected word indication with respect to a next adjacent word to a selected secondary word that is included in the selected word indication.

3. The method of claim 1, further comprising enabling performance of a selected function with respect to words included in the selected word indication.

4. The method of claim 1, wherein causing provision of the pre-selected word indication comprises causing provision of the pre-selected word indication with respect to a word immediately before the selected word indication and a word immediately after the selected word indication.

5. The method of claim 1, further comprising providing an expanded view of words in the selected word indication.

6. The method of claim 1, wherein the touch event responsive to which the expansion of the selected word indication is provided comprises a tap on a secondary word and wherein the touch gesture is a long press event.

7. The method of claim 1, wherein causing provision of the selected word indication comprises highlighting selected words, and wherein causing provision of the pre-selected word indication comprises differently highlighting secondary words positioned adjacent to the selected words.

8. An apparatus comprising at least one processor and at least one memory including computer program code, the at least one memory and the computer program code configured to, with the at least one processor, cause the apparatus at least to:
receive an indication of a touch gesture in association with a primary word among text being displayed at a touch screen display;
cause provision of a selected word indication to indicate inclusion of the primary word as a selected word;
cause provision of a pre-selected word indication in relation to at least one secondary word adjacent to the primary word; and
enable expansion of the selected word indication to include the at least one secondary word in response to a touch event selecting the at least one secondary word.

9. The apparatus of claim 8, wherein the at least one memory and computer program code are further configured to, with the at least one processor, cause the apparatus to cause provision of the pre-selected word indication with respect to a next adjacent word to a selected secondary word that is included in the selected word indication.

10. The apparatus of claim 8, wherein the at least one memory and computer program code are further configured to, with the at least one processor, cause the apparatus to enable performance of a selected function with respect to words included in the selected word indication.

11. The apparatus of claim 8, wherein the at least one memory and computer program code are configured to, with the at least one processor, cause the apparatus to cause provision of the pre-selected word indication by causing provision of the pre-selected word indication with respect to a word immediately before the selected word indication and a word immediately after the selected word indication.

12. The apparatus of claim 8, wherein the at least one memory and computer program code are further configured to, with the at least one processor, cause the apparatus to provide an expanded view of words in the selected word indication.

13. The apparatus of claim 8, wherein the touch event responsive to which the expansion of the selected word indication is provided comprises a tap on a secondary word and wherein the touch gesture is a long press event.

14. The apparatus of claim 8, wherein the at least one memory and computer program code are configured to, with the at least one processor, cause the apparatus to cause provision of the selected word indication by highlighting selected words, and wherein causing provision of the pre-selected word indication comprises differently highlighting secondary words positioned adjacent to the selected words.

15. The apparatus of claim 8, wherein the apparatus is a mobile terminal and further comprises user interface circuitry configured to facilitate user control of at least some functions of the mobile terminal.

16. A computer program product comprising at least one computer-readable storage medium having computer-executable program code instructions stored therein, the computer-executable program code instructions including program code instructions to:
receive an indication of a touch gesture in association with a primary word among text being displayed at a touch screen display;
cause provision of a selected word indication to indicate inclusion of the primary word as a selected word;
cause provision of a pre-selected word indication in relation to at least one secondary word adjacent to the primary word; and
enable expansion of the selected word indication to include the at least one secondary word in response to a touch event selecting the at least one secondary word.

17. The computer program product of claim 16, further comprising program code instructions for causing provision of the pre-selected word indication with respect to a next adjacent word to a selected secondary word that is included in the selected word indication.

18. The computer program product of claim 16, further comprising program code instructions for enabling performance of a selected function with respect to words included in the selected word indication.

19. The computer program product of claim 16, wherein the program code instructions for causing provision of the pre-selected word indication include instructions for causing provision of the pre-selected word indication with respect to a word immediately before the selected word indication and a word immediately after the selected word indication.

20. The computer program product of claim 16, wherein the touch event responsive to which the expansion of the selected word indication is provided comprises a tap on a secondary word and wherein the touch gesture is a long press event.
